(19) United States
(12) Patent Application Publication
(10) Pub. No.: US 2008/0233036 A1
(43) Pub. Date: Sep. 25, 2008

(54) PRODUCTION PROCESS FOR HIGH PURITY SILICON

(75) Inventor: SATOSHI HAYASHIDA, MINAMATA-SHI (JP)

Correspondence Address: J C PATENTS, INC., 4 VENTURE, SUITE 250, IRVINE, CA, 92618, US

(73) Assignee: CHISSO CORPORATION, OSAKA-SHI (JP)

(21) Appl. No.: 12/049,652

(22) Filed: Mar. 17, 2008

(30) Foreign Application Priority Data
Mar. 19, 2007 (JP) 2007-070284

(51) Int. Cl. C01B 33/039

(52) U.S. Cl. 423/348

(57) ABSTRACT

The production process for high purity silicon of the present invention comprises (1) a step in which metal silicon is reacted with hydrogen chloride gas, (2) a step in which a reaction product obtained is distilled to obtain silicon tetrachloride, (3) a step in which silicon tetrachloride obtained is reacted with zinc gas in a gas phase to produce high purity silicon, (4) a step in which zinc chloride by-produced is reacted with hydrogen gas and (5) a step in which zinc and hydrogen chloride are separated and recovered from a reaction product obtained, wherein zinc separated and recovered in the step (5) is used as a raw material for zinc gas in the step (3), and hydrogen chloride separated and recovered in the step (5) is used as a raw material for hydrogen chloride gas in the step (1).

### CROSS-REFERENCE TO RELATED APPLICATION

This application claims the priority benefit of Japan application serial no. 2007-070284, filed on Mar. 19, 2007. The entirety the above-mentioned patent application is hereby incorporated by reference herein and made a part of specification.

### BACKGROUND OF THE INVENTION

1. Field of the Invention

The present invention relates to a production process for high purity silicon. More specifically, it relates to a production process for high purity silicon in which silicon is produced from silicon tetrachloride by a zinc reduction process, wherein zinc chloride by-produced is reduced by hydrogen gas to separate and recover zinc and hydrogen chloride; zinc is used for reaction with silicon tetrachloride; and hydrogen chloride is used for producing silicon tetrachloride.

2. Description of Related Art

In recent years, requirement to reduce a discharge amount of carbon dioxide which is regarded as one of substances causing global warming is growing high. Accordingly, it is difficult to construct thermal power stations, so that increasing attentions are paid to photovoltaic power generation as a technique to meet new demand for electric power.

In photovoltaic power generation, a solar battery prepared by using silicon is used to obtain electricity from sunlight. Mainly silicons below standards in silicons for semiconductors are used for silicon for solar batteries, and assuming that photovoltaic power generation facilities are increased in the future and that demand to solar batteries dramatically grows larger as well, a supply amount of silicon is likely to be short.

In order to meet the above situation, silicon for solar batteries has to be produced separately from production of silicon for semiconductors. A process in which silicon is produced from silicon tetrachloride by a zinc reduction process is proposed as one of the processes, but treatment of a large amount of zinc chloride by-produced in the above process is a problem.

In order to solve the above problem, proposed is a process in which zinc chloride by-produced is electrolyzed to thereby recover zinc and chloride; zinc is used as a raw material for reduction of silicon tetrachloride; and chloride is converted into hydrogen chloride and used for producing silicon tetrachloride (refer to, for example, a patent document 1). However, the above process brings about the problems that the process is large-scaled in facilities and therefore requires a great amount of investment and that the silicon produced is increased in a cost.

Patent document 1: Japanese Patent Application Laid-Open No. 92130/1999.

### SUMMARY OF THE INVENTION

The invention relates to a production process for high purity silicon comprising:

(1) a step in which metal silicon is reacted with hydrogen chloride gas,

(2) a step in which a reaction product obtained in the step (1) is distilled to obtain silicon tetrachloride,

(3) a step in which silicon tetrachloride obtained in the step (2) is reacted with zinc gas in a gas phase in a reaction furnace having a temperature of 800 to 1200° C. to produce high purity silicon,

(4) a step in which zinc chloride by-produced in the step (3) is reacted with hydrogen gas,

(5) a step in which zinc and hydrogen chloride are separated and recovered from a reaction product obtained in the step (4), and

wherein zinc separated and recovered in the step (5) is used as a raw material for zinc gas supplied to the reaction in the step (3), and hydrogen chloride separated and recovered in the step (5) is used as a raw material for hydrogen chloride gas supplied to the reaction in the step (1).

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow sheet showing the production process for high purity silicon according to the present invention.

FIG. 2 is a schematic drawing showing one example of an apparatus in which zinc chloride is reacted with hydrogen gas in the production process of the present invention.

FIG. 3 is a schematic drawing showing one example of an apparatus in which zinc chloride is intermittently supplied and reacted with hydrogen gas in the production process of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present inventors have found that high purity polycrystal silicon can be produced at a relatively low cost by reacting hydrogen gas with zinc chloride by-produced in producing high purity silicon by gas phase reaction of silicon tetrachloride with zinc gas to separate and recover zinc and hydrogen chloride, using recovered zinc again for gas phase reaction with silicon tetrachloride and using recovered hydrogen chloride for reaction with metal silicon to produce silicon tetrachloride. Thus, the present invention comprising the following constitutions has been completer.

[1] A production process for high purity silicon comprising:

(1) a step in which metal silicon is reacted with hydrogen chloride gas,

(2) a step in which a reaction product obtained in the step (1) is distilled to obtain silicon tetrachloride,

(3) a step in which silicon tetrachloride obtained in the step (2) is reacted with a zinc gas in a gas phase in a reaction furnace having a temperature of 800 to 1200° C. to produce high purity silicon,

(4) a step in which zinc chloride by-produced in the step (3) is reacted with hydrogen gas,

(5) a step in which zinc and hydrogen chloride are separated and recovered from a reaction product obtained in the step (4), and

wherein zinc separated and recovered in the step (5) is used as a raw material for zinc gas supplied to the reaction in the step (3), and hydrogen chloride separated and recovered in the step (5) is used as a raw material for hydrogen chloride gas supplied to the reaction in the step (1).

[2] The production process for high purity silicon as described in [1], wherein zinc chloride supplied to the reaction in the step (4) is zinc chloride gas of 430 to 900° C.

[3] The production process for high purity silicon as described in [1] or [2], wherein the reaction of zinc chloride with hydrogen gas in the step (4) is carried out at a temperature of 700 to 1500° C.

[4] The production process for high purity silicon as described in any of [1] to [3], wherein in the step (5), the reaction product obtained in the step (4) is cooled down to 50° C. or lower; then, zinc is separated and recovered in the form of powder zinc, and hydrogen chloride is absorbed in water and separated and recovered.

[5] The production process for high purity silicon as described in any of [1] to [4], wherein in the step (5), unreacted hydrogen gas is further separated and recovered, and the unreacted hydrogen gas is used as hydrogen gas supplied to the reaction in the step (4).

[6] The production process for high purity silicon as described in any of [1] to [5], wherein in the step (2), hydrogen gas by-produced in the step (1) is separated and recovered, and the by-produced hydrogen gas is used as hydrogen gas supplied to the reaction in the step (4).

[7] The production process for high purity silicon as described in any of [1] to [6], wherein zinc chloride separated and recovered in the form of a liquid from reaction gas discharged in the step (3) by cooling the reaction gas to 732° C. or lower is supplied to the step (4); zinc separated and recovered from the reaction gas in the form of powder zinc is used as a raw material for zinc gas supplied in the step (3), and silicon tetrachloride separated and recovered from the reaction gas is used as silicon tetrachloride supplied to the step (3).

According to the present invention, zinc and hydrogen chloride each can be separated and recovered without using such large-scaled facilities as needed for molten salt electrolysis which requires a great amount of investment by reacting zinc chloride by-produced directly with hydrogen gas in producing silicon from silicon tetrachloride by a zinc reduction process, and therefore high purity silicon can efficiently be produced at a relatively low cost.

The production process for high purity silicon according to the present invention shall be explained below in details. The high purity silicon referred in the present invention means silicon having a purity of 99.99% or more, preferably 99.999% or more which can be used as a raw material for solar batteries.

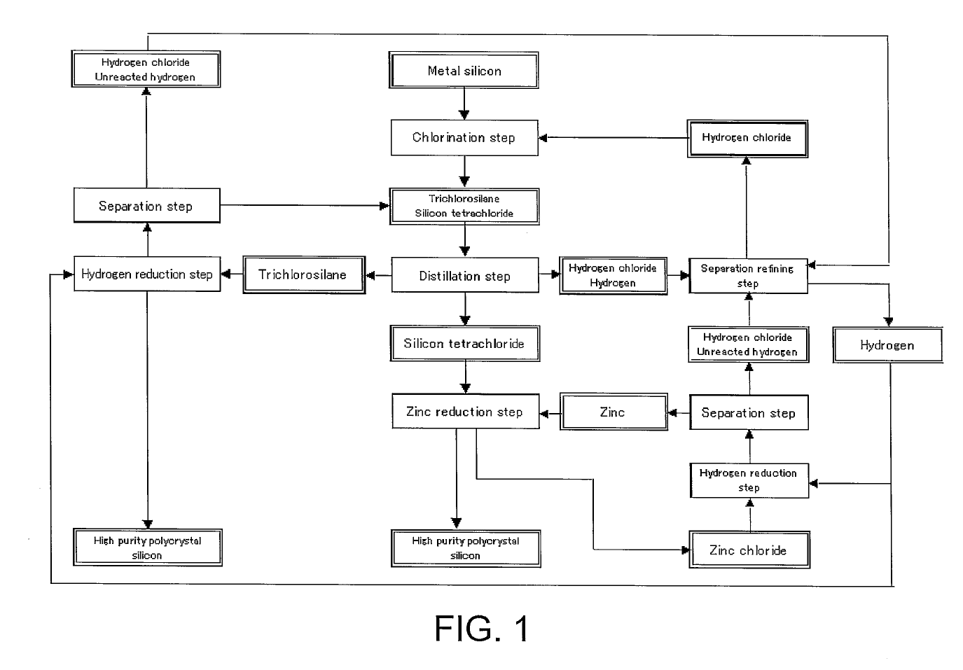

FIG. 1 is a flow sheet showing the production process for high purity silicon according to the present invention. As shown in FIG. 1, the production process for high purity silicon according to the present invention comprises (1) a chlorination step in which metal silicon used as a raw material is reacted with hydrogen chloride gas, (2) a distillation step in which silicon tetrachloride is separated from a reaction product obtained in the step (1) and refined, (3) a zinc reduction step in which silicon tetrachloride obtained in the step (2) is reacted with a zinc gas in a gas phase to produce high purity silicon, (4) a hydrogen reduction step in which zinc chloride by-produced in the step (3) is reacted with hydrogen gas and (5) a separation step in which zinc and hydrogen chloride are separated and recovered from a reaction product obtained in the step (4). The respective steps shall be explained below.

### (1) Chlorination Step:

In this step, crude metal silicon which is a raw material is reacted with hydrogen chloride gas to thereby produce silicon tetrachloride. The reaction of metal silicon with hydrogen chloride gas can be carried out by a publicly known method. To be specific, it can be carried out by a fluid bed reaction of metal silicon with hydrogen chloride gas in a reactor having a temperature of preferably 250 to 1000° C., more preferably 300 to 800° C. In the present step (1), silicon tetrachloride is produced as shown in the following formula. In addition thereto, trichlorosilane and hydrogen gas are by-produced, and the higher the temperature is, the proportion of silicon tetrachloride is enhanced.

Si+3HCl→SiHCl₃+H₂

Si+4HCl→SiCl₄+2H₂

Metal silicon supplied to the reaction in the present step (1) shall not specifically be restricted, and ferrosilicon having a purity of 75 to 95% and metal silicon having a purity of 95% or more can be used. Further, hydrogen chloride gas supplied to the reaction in the present step (1) shall not specifically be restricted, and hydrogen chloride recovered in the separation step (5) described later can be used as a part or a whole part of the raw material.

### (2) Distillation Step:

In this step, the reaction product obtained in the step (1) containing trichlorosilane, silicon tetrachloride and hydrogen gas is distilled to remove trichlorosilane and hydrogen gas and separate and refine silicon tetrachloride.

Hydrogen gas by-produced in the step (1) is separated and recovered in a separate way and can be used as hydrogen gas supplied to the reaction in the step (4) described later, and trichlorosilane can be used as a raw material in a hydrogen reduction reaction, a so-called Siemens method.

The distillation can be carried out according to publicly known methods and conditions. To be specific, the reaction production gas is condensed in a condenser to separate hydrogen gas, and the condensate is allowed to pass through a distillation tower and heated in an evaporation, whereby trichlorosilane can be taken out from a tower top, and silicon tetrachloride can be taken out from a tower bottom. Further, trichlorosilane and silicon tetrachloride each can be highly purified by repeatedly distilling them respectively.

### (3) Zinc Reduction Step:

In this step, silicon tetrachloride separated and refined in the distillation step (2) is reduced with zinc to produce high purity silicon. The reduction can be carried out by a gas phase reaction of silicon tetrachloride gas with zinc gas on publicly known conditions in publicly known facilities. To be specific, it can be carried out by reacting silicon tetrachloride gas with zinc gas in a reaction furnace having a temperature of 800 to 1200° C., preferably 900 to 100° C. If the reaction temperature falls in the range described above, silicon tetrachloride gas is reacted readily with zinc gas, and the reaction furnace is less liable to be damaged. A pressure of the reaction furnace is, for example, 0 to 500 kPaG.

In the present step (3), high purity silicon is produced and zinc chloride is by-produced as shown in the following reaction formula.

SiCl₄+2Zn→Si+2ZnCl₂

The reaction gas remaining after producing high purity silicon is a mixed gas containing zinc chloride, zinc, silicon tetrachloride and the like, and zinc chloride is separated and recovered in the form of a liquid by lowering the temperature to a boiling point of zinc chloride or lower, to be specific, 732° C. or lower, preferably about 500° C. Further, zinc is recovered in the form of powder or liquid zinc and can be used as a part of the raw material for zinc gas supplied to the present step (3). Remaining silicon tetrachloride can be used again as a part of the raw material gas supplied to the present step (3).

Zinc gas supplied to the reaction in the present step (3) shall not specifically be restricted, and the powder or liquid zinc recovered from the reaction gas described above containing unreacted zinc gas and powder zinc recovered in a separation step (5) described later can be used as the raw material therefor.

### (4) Hydrogen Reduction Step:

In this step, zinc chloride by-produced in the zinc reduction step (3) is reduced, as shown in the following reaction formula, by hydrogen gas to produce hydrogen chloride and zinc.

ZnCl₂+H₂→Zn+2HCl

The reduction reaction of zinc chloride with hydrogen gas is carried out at a temperature of preferably 700 to 1500° C., more preferably 800 to 1400° C. and particularly preferably 900 to 1300° C. The reduction reaction is carried out at hydrogen:zinc chloride of 2:1 to 200:1, more preferably 5:1 to 100:1 in terms of a mole ratio. It is carried out in a reaction retention time of preferably 0.01 to 1 second, more preferably 0.03 to 0.1 second. The present reaction is a reversible reaction, and therefore the temperature is forcibly lowered to a melting point of zinc or lower immediately after finishing the reaction. Zinc chloride is reduced by hydrogen gas on the above reaction conditions to obtain a fine powder of zinc.

Zinc chloride supplied to the reduction reaction in the present step (4) is zinc chloride gas of preferably 430 to 900° C., more preferably 500 to 800° C., and zinc chloride obtained in the step (3) which is evaporated and gasified is preferably supplied. Further, nitrogen gas and argon gas are preferably used, if necessary, as a carrier gas. Zinc chloride is evaporated and gasified on the conditions described above, whereby zinc chloride gas can stably be supplied to the reaction part.

Hydrogen gas supplied in the present step (4) shall not specifically be restricted, and capable of being reused are by-produced hydrogen gas which is by-produced in the chlorination step (1) and which is separated and recovered in the distillation step (2) and unreacted hydrogen gas separated and recovered in the separation step (5) described later.

### (5) Separation Step:

In this step, zinc, hydrogen chloride, unreacted zinc chloride and hydrogen gas are separated and recovered from the reaction product obtained in the hydrogen reduction step (4). In the separating and recovering method, by cooling the reaction product to 50° C. or lower, zinc can be separated and recovered in the form of powder zinc; unreacted zinc chloride is recovered in a solid form; hydrogen chloride can be absorbed in water or separated and recovered by cryogenic separation and membrane separation; and unreacted hydrogen gas can be separated and recovered.

Recovered zinc is used as a raw material for zinc gas supplied to the reaction in the zinc reduction step (3). Recovered hydrogen chloride is used as a raw material for hydrogen chloride gas supplied to the reaction in the chlorination step (1). When the hydrogen chloride supply is deficient, it is replenished with hydrogen chloride purchased as needed. Further, unreacted zinc chloride and hydrogen gas each recovered are reused respectively as zinc chloride and hydrogen gas supplied to the reaction in the hydrogen reduction step (4).

As described above, by-produced zinc chloride is reduced directly with hydrogen gas and therefore does not require such expensive facilities as needed for electrolysis, and zinc and hydrogen chloride produced are effectively circulated and used. The steps (4) and (5) in the production process of the present invention shall specifically be explained below.

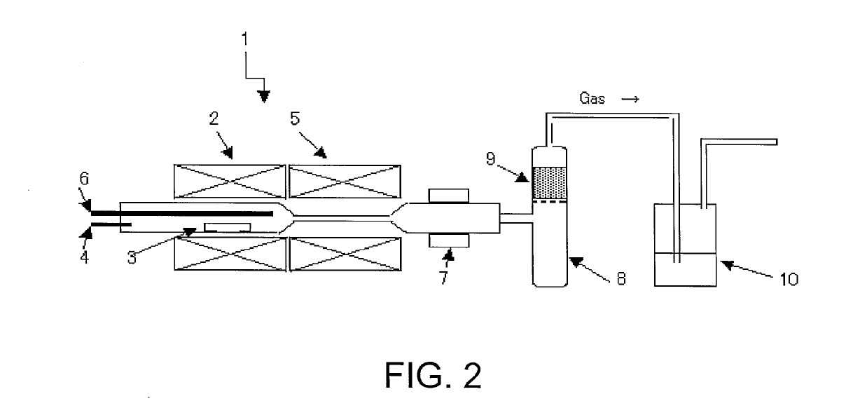

FIG. 2 is a schematic drawing showing one example of an apparatus in which zinc chloride by-produced in the step (3) of the production process for high purity silicon according to the present invention is reacted with hydrogen gas and in which zinc, hydrogen chloride and the unreacted raw materials are separated and recovered from the reaction product obtained. A reactor 1 is horizontal tubular and comprises an evaporation part 2, a reaction part 5 and a cooling part 7. The temperatures of the evaporation part 2 and the reaction part 5 are controlled respectively by electrically heated furnaces present outside the tubes, and the cooling part 7 is cooled by air from the outside of the tube.

Zinc chloride is evaporated and gasified by electrically heating from the outside of the tube in the quartz-made evaporator 3, and it is turned into zinc chloride gas of preferably 430 to 900° C., more preferably 500 to 800° C. The zinc chloride gas is introduced into the reaction part 5 together with a carrier gas (usually nitrogen gas) supplied from a carrier gas supplying part 4 at a side of the evaporation part 2 in the reactor. The carrier gas may not necessarily be used.

The zinc chloride gas is brought into contact and mixed in the reaction part 5 with hydrogen gas supplied from a hydrogen gas supplying part 6 at a side of the evaporation part 2 in the reactor 1 to be reacted therewith. This reaction is carried out at preferably 700 to 1500° C., more preferably 800 to 1300° C., and the reaction temperature is controlled by an electric furnace in the reaction part.

The reaction product is cooled down to 50° C. or lower in the cooling part 7, and then zinc is separated and recovered in the form of powder zinc. Hydrogen chloride is absorbed in water in a hydrogen gas absorber 10 and separated and recovered, and unreacted zinc chloride and hydrogen gas can be used again for the reaction.

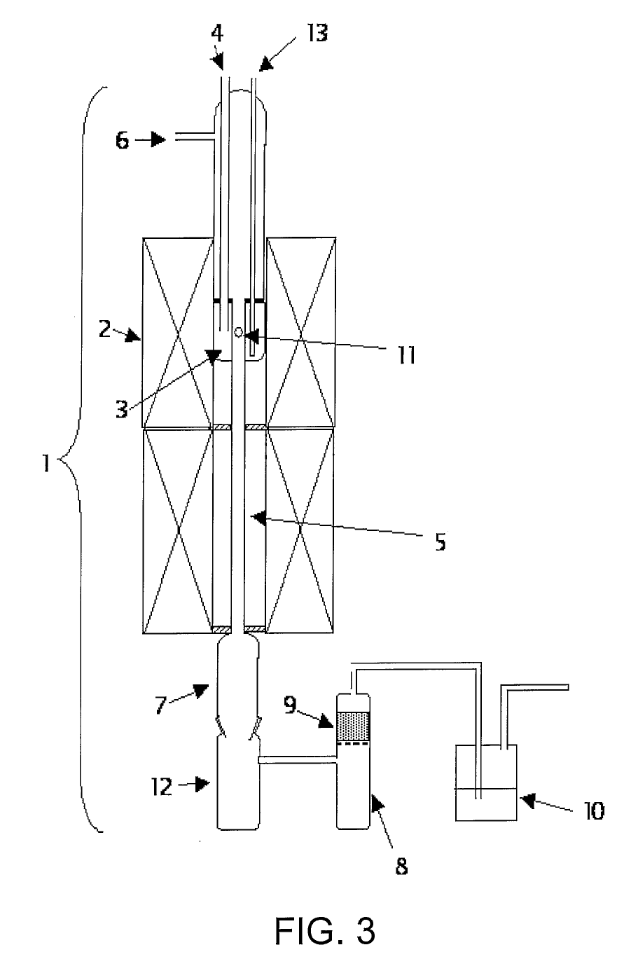

In a reactor 1 shown in FIG. 3, an evaporation part 2 is a vertical type unlike the case of FIG. 2, wherein zinc chloride is supplied intermittently from a zinc chloride gas inlet 11 to a quartz-made evaporator 3, and powder zinc is semi-continuously produced.

In the production process for high purity silicon according to the present invention, a reaction apparatus in which by-produced zinc chloride is reacted with hydrogen gas may be either a horizontal type reaction tube or a vertical type reaction tube. In general, quartz is used as a material of the reaction tube in order to enhance the heat resistance and prevent impurities from being mixed in.

### EXAMPLES

The present invention shall more specifically be explained below with reference to examples, but the present invention shall not be restricted to these examples.

### Example 1

(1) Chlorination Step:

A quartz-made reactor was charged with 50 g of metal silicon and heated by an electric furnace so that metal silicon reached 300° C. Then, hydrogen chloride gas was supplied to the reactor from a lower part of the reactor at a rate of 150 NL/hour, and metal silicon was supplied at 60 g/hour to carry out the reaction for 10 hours. A chlorosilane gas produced was condensed by means of a brine condenser and collected to obtain 3000 g of a reaction liquid. The composition of the reaction liquid thus obtained which was measured by gas chromatographic analysis comprised 85.2% of trichlorosilane and 14.0% of silicon tetrachloride, and the total amount of impurity metal compounds contained in the reaction liquid which was measured by a high frequency induction plasma emission spectrometry (ICP-AES) was 140 ppm.

(2) Distillation Step:

The impurity metal compounds were removed from the reaction liquid obtained by single distillation, and then distillation was carried out repeatedly in a rectifying tower having a theoretical plate number of 30. The distillation was carried out repeatedly until silicon tetrachloride reached a purity of 99.99% or more which was measured by gas chromatographic analysis and was reduced to 1 ppm or less of the total amount of impurity metal compounds which was measured by a high frequency induction plasma emission spectrometry (ICP-AES), whereby 160 g of silicon tetrachloride was obtained.

(3) Zinc Reduction Step:

A reactor was heated by an electric furnace so that a whole part reached about 950° C. Then, silicon tetrachloride gas of 950° C. which was obtained in the step (2) as a silicon chloride gas and a zinc gas of 950° C. as a reducing gas were supplied to the reactor at silicon tetrachloride: zinc of 0.7:1 in terms of a mole ratio, and they were reacted for 7.5 hours to obtain 9.8 g of high purity silicon having a purity of 99.999%. Further, the reaction gas obtained after producing the high purity silicon was cooled down to 200° C., whereby 123 g of by-produced zinc chloride having a purity of 85% was obtained. A purity of the high purity silicon was determined by the high frequency induction plasma emission spectrometry (ICP-AES). Further, after the by-produced zinc chloride was dissolved in purified water to remove unreacted zinc, a purity of the by-produced zinc chloride was determined by a proportion of insoluble zinc, water-soluble zinc titration and Cl titration.

(4) Hydrogen Reduction Step:

The quartz-made reactor 1 shown in FIG. 2 was used to charge the quartz-made evaporator 3 in the evaporation part 2 with about 20 g of the by-produced zinc chloride (purity: 85%) obtained in the step (3), and it was evaporated at 600° C.

Nitrogen gas was supplied as a carrier gas at 1 L/hour from a carrier gas supplying part 4 to the reaction part 5 of 1200° C., and hydrogen gas was supplied at 130 L/hour from the hydrogen gas supplying part 6 to the reaction part 5.

(5) Separation Step:

Zinc produced in the step (4) was collected in the form of powder zinc in the cooling part 7 or the dust trap 8. The powder zinc thus obtained had a purity of 99.99% by weight or more, and it was a purity which could be used for zinc used in a zinc reduction method of silicon tetrachloride. The analytical results of impurities contained in the powder zinc which were measured by the high frequency induction plasma emission spectrometry (ICP-AES) are shown in Table 1. Further, hydrogen chloride produced was absorbed in water in the hydrogen chloride gas absorber 10 and recovered, and it was separated from unreacted hydrogen gas.

The above process repeated (5) from (4) six times, and then zinc separated and recovered in the step (5) was used as a raw material for zinc gas supplied to the reaction in the step (3), and hydrogen chloride separated and recovered in the step (5) was used as a raw material for hydrogen chloride gas supplied to the reaction in the step (1).

### Reference Example 1

Powder zinc, hydrogen chloride and unreacted hydrogen gas were separated and recovered in the same manner as in Example 1, except that a zinc chloride reagent (purity: 99.23%, manufactured by Toshin Chemical Industry Co., Ltd.) was used in place of the by-produced zinc chloride obtained in the zinc reduction step (3) of Example 1. Powder zinc obtained had a purity of 99.99% by weight or more. The analytical results of impurities contained in the powder zinc which were measured by the high frequency induction plasma emission spectrometry (ICP-AES) are shown in Table 1.

### Reference Example 2

In the hydrogen reduction step (4) of Example 1, a quartz-made reactor 1 shown in FIG. 3 was used to charge a quartz-made evaporator 3 in an evaporation part 2 with about 40 g of a dehydrated zinc chloride reagent (manufactured by Toshin Chemical Industry Co., Ltd.), and it was evaporated at 710° C. Nitrogen gas was supplied as a carrier gas at 1 L/hour from a carrier gas supplying part 4 to a reaction part 5 of 1200° C., and hydrogen gas was supplied at 90 L/hour from a hydrogen gas supplying part 6 to the reaction part 5. Zinc produced was collected in the form of powder zinc in a cooling part 7 or a dust trap 8, and powder zinc, hydrogen chloride and unreacted hydrogen gas were separated and recovered. The powder zinc thus obtained had a purity of 99.99% by weight or more, and it was a purity which could be used for zinc used in a zinc reduction method of silicon tetrachloride. The analytical results of impurities contained in the powder zinc which were measured by the high frequency induction plasma emission spectrometry (ICP-AES) are shown in Table 1.

TABLE 1

| | | Reference | Reference |
|---|---|---|---|
| Unit ppm | Example 1 | Example 1 | Example 2 |
| Fe | 10 | 31 | <1 |
| Al | <5 | <5 | <5 |
| Ca | <5 | <5 | <5 |
| Cd | <1 | <1 | <1 |
| Co | <1 | <1 | <1 |
| Cr | <1 | <1 | <1 |
| Cu | <1 | <1 | <1 |
| K | <5 | <5 | <5 |
| Li | <1 | <1 | <1 |
| Mg | <1 | <1 | <1 |
| Mn | <1 | <1 | <1 |
| Na | <5 | 7 | <5 |
| Ni | <1 | <1 | <1 |
| Pb | 8 | 9 | <1 |
| Sn | <1 | 2 | <1 |
| Ti | <1 | <1 | <1 |
| B | <1 | <1 | <1 |
| P | <10 | <10 | <10 |

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A production process for high purity silicon, comprising:
(1) a step in which metal silicon is reacted with hydrogen chloride gas;
(2) a step in which a reaction product obtained in the step (1) is distilled to obtain silicon tetrachloride;
(3) a step in which silicon tetrachloride obtained in the step (2) is reacted with zinc gas in a gas phase in a reaction furnace having a temperature of 800 to 1200° C. to produce high purity silicon;
(4) a step in which zinc chloride by-produced in the step (3) is reacted with hydrogen gas; and
(5) a step in which zinc and hydrogen chloride are separated and recovered from a reaction product obtained in the step (4); and
wherein zinc separated and recovered in the step (5) is used as a raw material for zinc gas supplied to the reaction in the step (3), and hydrogen chloride separated and recovered in the step (5) is used as a raw material for hydrogen chloride gas supplied to the reaction in the step (1).

2. The production process for high purity silicon as described in claim 1, wherein zinc chloride supplied to the reaction in the step (4) is zinc chloride gas of 430 to 900° C.

3. The production process for high purity silicon as described in claim 1, wherein the reaction of zinc chloride with hydrogen gas in the step (4) is carried out at a temperature of 700 to 1500° C.

4. The production process for high purity silicon as described in claim 1, wherein in the step (5), the reaction product obtained in the step (4) is cooled down to 50° C. or lower; then, zinc is separated and recovered in the form of powder zinc, and hydrogen chloride is absorbed in water and separated and recovered.

5. The production process for high purity silicon as described in claim 1, wherein in the step (5), unreacted hydrogen gas is further separated and recovered, and the unreacted hydrogen gas is used as hydrogen gas supplied to the reaction in the step (4).

6. The production process for high purity silicon as described in claim 1, wherein in the step (2), hydrogen gas by-produced in the step (1) is separated and recovered, and the by-produced hydrogen gas is used as hydrogen gas supplied to the reaction in the step (4).

7. The production process for high purity silicon as described in claim 2, wherein in the step (2), hydrogen gas by-produced in the step (1) is separated and recovered, and the by-produced hydrogen gas is used as hydrogen gas supplied to the reaction in the step (4).

8. The production process for high purity silicon as described in claim 3, wherein in the step (2), hydrogen gas by-produced in the step (1) is separated and recovered, and the by-produced hydrogen gas is used as hydrogen gas supplied to the reaction in the step (4).

9. The production process for high purity silicon as described in claim 4, wherein in the step (2), hydrogen gas by-produced in the step (1) is separated and recovered, and the by-produced hydrogen gas is used as hydrogen gas supplied to the reaction in the step (4).

10. The production process for high purity silicon as described in claim 5, wherein in the step (2), hydrogen gas by-produced in the step (1) is separated and recovered, and the by-produced hydrogen gas is used as hydrogen gas supplied to the reaction in the step (4).

11. The production process for high purity silicon as described in claim 1, wherein zinc chloride separated and recovered in the form of a liquid from reaction gas discharged in the step (3) by cooling the reaction gas to 732° C. or lower is supplied to the step (4); zinc separated and recovered from the reaction gas in the form of powder zinc is used as a raw material for zinc gas supplied in the step (3), and silicon tetrachloride separated and recovered from the reaction gas is used as silicon tetrachloride supplied to the step (3).

12. The production process for high purity silicon as described in claim 2, wherein zinc chloride separated and recovered in the form of a liquid from reaction gas discharged in the step (3) by cooling the reaction gas to 732° C. or lower is supplied to the step (4); zinc separated and recovered from the reaction gas in the form of powder zinc is used as a raw material for zinc gas supplied in the step (3), and silicon tetrachloride separated and recovered from the reaction gas is used as silicon tetrachloride supplied to the step (3).

13. The production process for high purity silicon as described in claim 3, wherein zinc chloride separated and recovered in the form of a liquid from reaction gas discharged in the step (3) by cooling the reaction gas to 732° C. or lower is supplied to the step (4); zinc separated and recovered from the reaction gas in the form of powder zinc is used as a raw material for zinc gas supplied in the step (3), and silicon tetrachloride separated and recovered from the reaction gas is used as silicon tetrachloride supplied to the step (3).

14. The production process for high purity silicon as described in claim 4, wherein zinc chloride separated and recovered in the form of a liquid from reaction gas discharged in the step (3) by cooling the reaction gas to 732° C. or lower is supplied to the step (4); zinc separated and recovered from the reaction gas in the form of powder zinc is used as a raw material for zinc gas supplied in the step (3), and silicon tetrachloride separated and recovered from the reaction gas is used as silicon tetrachloride supplied to the step (3).

15. The production process for high purity silicon as described in claim 5, wherein zinc chloride separated and recovered in the form of a liquid from reaction gas discharged in the step (3) by cooling the reaction gas to 732° C. or lower is supplied to the step (4); zinc separated and recovered from the reaction gas in the form of powder zinc is used as a raw material for zinc gas supplied in the step (3), and silicon tetrachloride separated and recovered from the reaction gas is used as silicon tetrachloride supplied to the step (3).

16. The production process for high purity silicon as described in claim 6, wherein zinc chloride separated and recovered in the form of a liquid from reaction gas discharged in the step (3) by cooling the reaction gas to 732° C. or lower is supplied to the step (4); zinc separated and recovered from the reaction gas in the form of powder zinc is used as a raw material for zinc gas supplied in the step (3), and silicon tetrachloride separated and recovered from the reaction gas is used as silicon tetrachloride supplied to the step (3).

17. The production process for high purity silicon as described in claim 7, wherein zinc chloride separated and recovered in the form of a liquid from reaction gas discharged in the step (3) by cooling the reaction gas to 732° C. or lower is supplied to the step (4); zinc separated and recovered from the reaction gas in the form of powder zinc is used as a raw material for zinc gas supplied in the step (3), and silicon tetrachloride separated and recovered from the reaction gas is used as silicon tetrachloride supplied to the step (3).

18. The production process for high purity silicon as described in claim 8, wherein zinc chloride separated and recovered in the form of a liquid from reaction gas discharged in the step (3) by cooling the reaction gas to 732° C. or lower is supplied to the step (4); zinc separated and recovered from the reaction gas in the form of powder zinc is used as a raw material for zinc gas supplied in the step (3), and silicon tetrachloride separated and recovered from the reaction gas is used as silicon tetrachloride supplied to the step (3).

19. The production process for high purity silicon as described in claim 9, wherein zinc chloride separated and recovered in the form of a liquid from reaction gas discharged in the step (3) by cooling the reaction gas to 732° C. or lower is supplied to the step (4); zinc separated and recovered from the reaction gas in the form of powder zinc is used as a raw material for zinc gas supplied in the step (3), and silicon tetrachloride separated and recovered from the reaction gas is used as silicon tetrachloride supplied to the step (3).

20. The production process for high purity silicon as described in claim 10, wherein zinc chloride separated and recovered in the form of a liquid from reaction gas discharged in the step (3) by cooling the reaction gas to 732° C. or lower is supplied to the step (4); zinc separated and recovered from the reaction gas in the form of powder zinc is used as a raw material for zinc gas supplied in the step (3), and silicon tetrachloride separated and recovered from the reaction gas is used as silicon tetrachloride supplied to the step (3).
